(19) United States
(12) Patent Application Publication
(10) Pub. No.: US 2010/0078489 A1
(43) Pub. Date: Apr. 1, 2010

(54) ECO-FRIENDLY CARDS, ACCESSORIES AND METHODS FOR FABRICATING THE SAME

(75) Inventor: Marvin Winkler, Los Angeles, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: Winkler and Sons, Inc.

(21) Appl. No.: 12/413,233

(22) Filed: Mar. 27, 2009

Related U.S. Application Data
(60) Provisional application No. 61/101,482, filed on Sep. 30, 2008.

(51) Int. Cl. G06K 19/02; B32B 37/00

(52) U.S. Cl. 235/493; 156/60

(57) ABSTRACT

Disposable eco-friendly cards formed from a recyclable and/or biodegradable material are provided. The eco-friendly card may include a card body and an identification means. The card body may be formed from a recyclable material, plantable paper material and/or a biodegradable material. The identification means, may be coupled to the card body, for identifying the eco-friendly card and/or the cardholder. The identification means may include a magnetic stripe or a bar code.

### RELATED APPLICATION

This application claims the benefit of and priority to U.S. Provisional Application Ser. No. 60/101,482, filed Sep. 30, 2008, the contents of which are incorporated by reference herein in its entirety.

### BACKGROUND

This disclosure relates generally to environmentally friendly cards and accessories. The disclosure more specifically relates to recyclable, plantable and/or biodegradable cards, such as credit cards, debit cards, ATM cards, charge cards, gift cards, identity cards, smart cards, keycards, metro and bus cards, access cards, customer rewards cards, and related items needed in the marketplace.

### SUMMARY

An environmentally friendly card is disclosed. The environmentally friendly card may include a card body and a magnetic stripe. The card body has a front side and a back side. The card body may be formed from recyclable, plantable and/or biodegradable materials. The magnetic stripe may be formed on the back side of the card body using a recyclable material and/or a biodegradable material as well. In one embodiment, the environmentally friendly card may include a chip for processing the data. The chip may be formed on the front side of the card body using also a recyclable material and/or a biodegradable material. Information may be printed on the card body using ink that glows in the dark. In one embodiment, the environmentally friendly card may include an outer covering formed of a corn starch adhesive for providing exterior strength and firmness to the card body. The environmentally friendly card may also include an activation means for exposing the biodegradable material. The activation means may be a peelable tab and/or a fault on at least one surface of the card body.

In one embodiment, a disposable card comprising a biodegradable magnetic stripe for storing data is provided. The disposable card may include a biodegradable polymeric chip for processing the data.

In yet another embodiment, an eco-friendly card is provided. The eco-friendly card may include a card body and an identification means. The card body may be formed from a paper material with at least one plant seed coupled thereto. The eco-friendly card may include means for providing nutrients to the at least one plant seed. The identification means, may be coupled to the card body, for identifying the eco-friendly card and/or the cardholder. The identification means may include a magnetic stripe or a bar code.

### DRAWINGS

The above-mentioned features and objects of the present disclosure will become more apparent with reference to the following description taken in conjunction with the accompanying drawings wherein like reference numerals denote like elements and in which:

FIG. 1A illustrates a front side of a recyclable or a biodegradable card, according to an embodiment of the present disclosure.

FIG. 1B illustrates a back side of the recyclable or biodegradable card of FIG. 1A, according to an embodiment of the present disclosure.

FIG. 2A illustrates a front side of a recyclable or a biodegradable card, according to another embodiment of the present disclosure.

FIG. 2B illustrates a back side of the recyclable or biodegradable card of FIG. 2A, according to another embodiment of the present disclosure.

### DETAILED DESCRIPTION

In the description that follows, the present disclosure will be described in reference to a preferred embodiment that utilizes a recyclable, plantable or biodegradable material for cards, such as credit cards, charge cards, smart cards, identity cards, gift cards, keycards, metro and bus cards, access cards, customer rewards cards, and the like. The present disclosure, however, is not limited to any particular application nor is it limited by the examples described herein. Therefore, the description of the embodiments that follow are for purposes of illustration and not limitation.

PVC plastic has been widely used to make cards, such charge cards, identity cards, access cards, and the like. When produced or incinerated, PVC plastic releases carcinogens and toxins, such as dioxins, that are hazardous to humans and the environment. Since many cards are lost or fail to work, they end up making their way to landfills. There, the cards may decay over several years, and many remain in essentially unaltered form for generations. According to one embodiment of the present invention, these cards may be fabricated from recyclable, biodegradable or substantially biodegradable material(s).

The term “recyclable,” as used herein, may mean subject to processing for reuse into a new product to prevent waste of potentially useful material, reduce the consumption of fresh raw materials and/or reduce the need for conventional waste disposal. The processing for reuse may be accomplished through mechanical or environmental conditions. The term may also include using again in original form or with minimal alteration or, to alter or adapt for new use with or without changing the essential form or nature. As is well known to persons skilled in the pertinent art, recyclable materials may include glass, paper, cardboard, paperboard, wood, metal, textiles, etc. As can be appreciated, the paper may be made of a plantable material, for example, but not limited to, plantable seed paper. The plantable seed paper, when planted, may be processed for reuse by mother nature into new product(s) such flowers, herbs, shrubs and/or even trees.

The term “biodegradable,” as used herein, may mean subject to chemical degradation, usually oxidation, by exposure to biological or environmental conditions. The term includes degradation by exposure to ultraviolet light, sunlight, fluids, temperatures and pressures normally found in landfills, bacteria (both aerobic and anaerobic) and any other condition found in the biosphere.

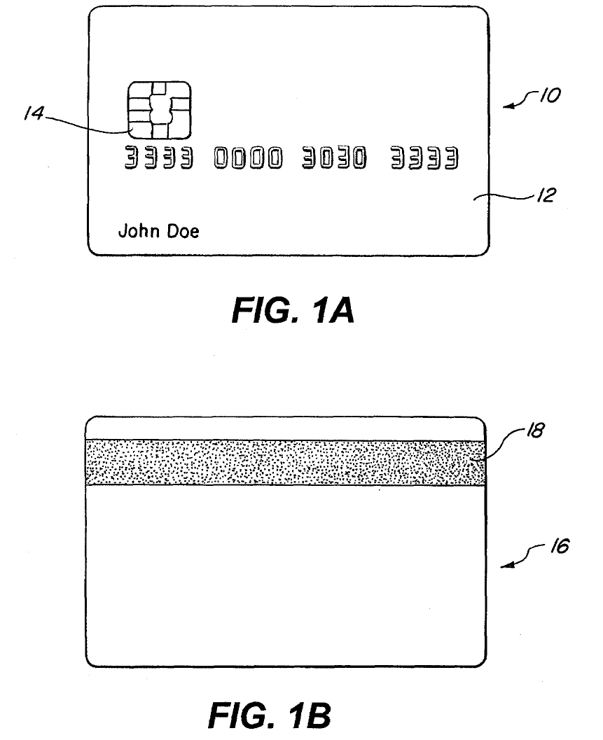

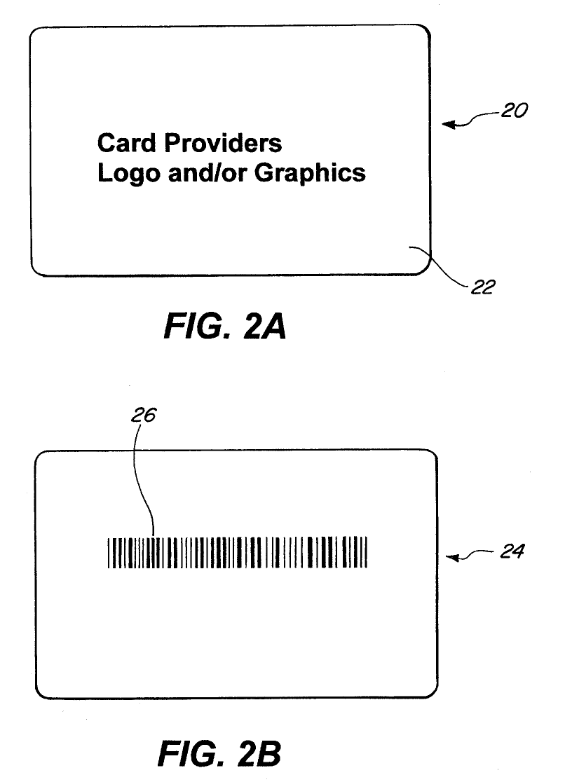

FIG. 1A illustrates a front side 10 of a card 12, according to an embodiment of the present disclosure. FIG. 2B illustrates a back side 16 of the card 12 of FIG. 1A. In one embodiment, the card 12 may be made of recyclable and/or biodegradable material. As can be appreciated, the card 12 may include a chip 14 and/or an identifier in a designated zone, area or space, such as magnetic stripe 18. The magnetic stripe 18 may be used to store data by modifying the magnetism of magnetic particles on the card 12. The chip 14 may be an embedded integrated circuit for processing data. In one embodiment, the chip 14 and/or the magnetic stripe 18 may be made of a recyclable or biodegradable material. For example, the magnetic stripe 18 may be made of a biodegradable magnetic material, as described in U.S. Pat. Nos. 5,382,468 and 5,225,282, the contents of each of which are incorporated by reference herein in its entirety. Similarly, the chip 14 may be made of a biodegradable polymeric chip, as described in Yoshihiro Ito et al., A microfabrication method of a biodegradable polymer chip for a controlled release system, in JOURNAL OF BIOMATERIALS SCIENCE No. 16, at 949-955 (Polymer edition, 2005), and as described in Jina Kim, Lamination of a biodegradable polymeric microchip, (Massachusetts Institute of Technology, Dept. of Materials Science and Engineering Thesis, 2006), the contents of each of which are incorporated by reference herein in its entirety.

The biodegradable material may be environmentally safe composites of rendered by-products from animal groups. Animal by-product may be used as the raw material for fabricating the card 12. Fish by-product, such as skin, scales, bone, soft tissue and/or organs may also be used as the raw material for fabricating the card 12. The raw material may also be made from cellulose derived materials or starch based biodegradable materials.

In one embodiment, the raw material may be crushed and placed in a cooker for a predetermined temperature to remove excess fats, tumbled dried and then ground to very fine powder. The powder may then be molded and pressed to the shape of the biodegradable card 12. An adhesive, such as a corn starch adhesive, may be applied on the card 12 to add exterior strength and firmness. As can be appreciated, the card 12 may decompose or disintegrate within about 48 hours once in contact with air or water. As such, the card 12 may be implemented in a disposable single-use type card, for example, a metro or bus card.

In one embodiment, biodegradable polymers may be used as the raw material for fabricating the biodegradable card 12. For example, biodegradable polymer, such as NOVON brand, a starch-based polymer described in U.S. Pat. No. 4,673,438 and U.S. Pat. No. 4,738,724, incorporated herein by reference. Biodegradable cards 12 made from such a material may be broken down in landfills in a short period.

In one embodiment, the card 12 may be fabricated of a substantially biodegradable material having a biodegradable inner layer or core, an outer layer that resists degradation, and an activation means coupled to the outer layer that, when activated, exposes the biodegradable inner layer or core to the environment. The outer layer may be biodegradable, but preferably less so than the inner core. If the outer layer is made of a non-biodegradable material, such as polyurethane, the thickness of the outer layer is preferably small enough to provide protection to the inner core, for example, 0.1% of the card's overall thickness. The outer layer may be applied to the inner layer or core by co-molding, co-extrusion, spraying, painting, dipping, shrink wrapping and/or dripping.

The activation means may be used to expose the inner core for degradation and/or disintegration. In one embodiment, the activation means may include a peelable tab on at least one surface of the card 12, which when removed, exposes the inner core for degradation and/or disintegration. In another embodiment, the activation means may include a biodegradable material, less so than the inner core, and covering an opening in the outer layer that exposes the inner core. As such, the card 12 may be designed to have a useful life of a predetermined period or predetermined number of uses. For example, the activation means may be a biodegradable material that disintegrates after exposure to air or water for a week. In yet another embodiment, the activation means may include a fault, such as a V-notch, groove or indentation in the card 12 to allow breakage of the outer layer by manual pressure exerted by the user so as to expose the inner layer or core for degradation or disintegration.

The skilled artisan will be aware of other available environmentally safe materials, all of which are encompassed by the present disclosure.

In one embodiment, data may be stored on recyclable and/or biodegradable cards using bar code technology. FIG. 2A illustrates a front side 20 of a recyclable and/or a biodegradable card 22, according to another embodiment of the present disclosure. FIG. 2B illustrates a back side 24 of the recyclable or biodegradable card 22 of FIG. 2A. As can be appreciated, the card 22 may include an identifier, such as bar code 26. The bar code 26 may be imprinted, printed, or applied (collectively or individually referred to herein as “formed”) on the front side 20 or the back side 24 of the card 22. FIG. 2B shows the bar code 26 on the back side 24 of the card 22.

The bar code 26 may be used to provide an optical machine-readable representation of the data associated with the card 22. As can be appreciated, the bar code 26 may be a 1 dimensional (1D) linear symbology, a 2 dimensional (2D) matrix symbology, and the like. The 1D linear symbology represent data in the widths (lines) and the spacings of parallel lines. The 2D matrix symbology represent data in patterns of squares, dots, hexagons and other geometric patterns within images. Once scanned by a bar code reader, the data may be retrieved from a database to identify the cardholder, provide access to the card holder, or identify a card holder's account. As can be appreciated, the bar code 26, the magnetic stripe 18, and the like, may be used as identification means for identifying the card 12 or 22 to provide access, identify the cardholder or identify the cardholder's account associated with the card 12 or 22.

In one embodiment, information may be displayed on the front side 20 and the back side 24 of the card 22. For example, information such as card provider's name, card provider's logo, card holder's name, writing, graphics or images, account number, and the like. In one embodiment, the information may be imprinted, typed, printed, or applied on the card 22 by other methods known to a person skilled in the art. Any ink color may be used to apply the information, such as graphics or images, on the card 22, including, but not limited to, ink that glows in the dark. As can be appreciated, the ink may be a biodegradable polymer, such as, but not limited to, polyhydroxyalkanoate (PHA), polylactic acid (PLA), poly (lactic-co-glycolic) acid (PLGA), polyvinyl alcohol (PVA), polyglycolic acid (PGA), polyvinyl pyrrolidone (PVP), polycaprolactone (PCL), polymer derived from adipic acid or aminocaproic acid, and poly(butylene succinate), or a derivative or a mixture thereof, as described in U.S. Publication No. 20050215662, the contents of which are incorporated by reference herein in its entirety.

As can be appreciated, the card 12 or 22 may be fabricated of a recyclable and biodegradable material. For example, the card 12 or 22 may be fabricated of a recyclable plantable paper with one or more biodegradable materials, such as but not limited to, a biodegradable magnetic stripe 18 and/or a biodegradable chip 14. As such, the decomposition or degradation of the biodegradable material may provide nutrients for the plantable seed paper to grow flowers, herbs, shrubs and/or even trees.

In one embodiment, the plantable paper material may be fabricated by placing shredded paper and warm water in a blender until no paper flakes remain and pulp appears smooth. Next, seeds of a desirable plant product is stirred in the pulp. The paper-seed mixture may be poured in a mold of desired size and shape, and allowed to dry for 12 to 24 hours. Alternatively, a mesh may be mounted onto a frame of desired size and shape and introduced in the paper-seed mixture to allow a layer of paper-seed mixture to settle on the mesh. The frame may then be slowly lifted up from the paper-seed mixture to allow it to drain any water. The frame may then be placed (pulp side down) onto a fabric or cloth material. A sponge may be used to press out as much water as possible. Next, the frame may be removed and the paper-seed mixture is left on the fabric or cloth. The paper-seed mixture may then be placed out in the sun or other heat source to dry up. When dried, the paper-seed mixture may be separated from the fabric or cloth material and cutters or stencils of desired shape may be used to form the plantable card 12 or 22. An adhesive, such as a corn starch adhesive, may be applied on the plantable card 12 or 22 to add exterior strength and firmness. As can be appreciated, the biodegradable magnetic stripe 18 and/or the biodegradable chip 14 may then be formed on the plantable card 12. Similarly, the bar code 26 may be imprinted, typed, printed, or applied on the plantable card 22.

While the recyclable and/or biodegradable cards 12 and 22 have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. An eco-friendly card comprising:
a card body having a front side and a back side, the card body formed from a first material selected from a group consisting of a recyclable material and a biodegradable material; and
a designated zone for storing data, formed on the back side of the card body using a second material selected from a group consisting of a recyclable material and a biodegradable material.

2. The eco-friendly card of claim 1, wherein the designated zone is a magnetic stripe.

3. The eco-friendly card of claim 1 further comprising a chip for processing the data, formed on the front side of the card body using a third material selected from a group consisting of a recyclable material and a biodegradable material.

4. The eco-friendly card of claim 1, wherein the biodegradable material is at least one material selected from a group of an environmentally safe composite, a pulverized animal-by-product, a pulverized fish-by-product, a cellulose derived material, and a starch-based polymer.

5. The eco-friendly card of claim 1, further comprising an outer covering formed of a corn starch adhesive for providing exterior strength and firmness to the card body.

6. The eco-friendly card of claim 1, further comprising an activation means for exposing the biodegradable material, the activation means selected from a group consisting of a peelable tab and a fault on at least one surface of the card body.

7. The eco-friendly card of claim 1, wherein the recyclable material is at least one material selected from a group consisting of glass, paper, cardboard, paperboard, wood, metal and textiles.

8. The eco-friendly card of claim 1, wherein the first material comprises a plantable seed paper.

9. A disposable card comprising a biodegradable magnetic stripe for storing data.

10. The disposable card of claim 9, further comprising a biodegradable polymeric chip for processing the data.

11. The disposable card of claim 9, further comprising a card body formed of a plantable seed paper material.

12. An eco-friendly card comprising:
a card body formed from a first material selected from a group consisting of a recyclable material and a biodegradable material; and
identification means, coupled to the card body, for identifying the eco-friendly card.

13. The eco-friendly card of claim 12, wherein the identification means comprises a magnetic stripe for storing identification data, formed on the card body using a second material selected from a group consisting of a recyclable material and a biodegradable material.

14. The eco-friendly card of claim 12, wherein the identification means comprises a bar code for providing optical representation of identification data.

15. The eco-friendly card of claim 12 further comprising a chip for processing data from the identification means, formed on the card body using a third material selected from a group consisting of a recyclable material and a biodegradable material.

16. The eco-friendly card of claim 12, wherein the first material comprises a paper material with at least one plant seed coupled thereto.

17. The eco-friendly card of claim 12, further comprising
at least one plant seed coupled to the card body; and
means for providing nutrients to the at least one plant seed.

18. A method for fabricating an eco-friendly card, the method comprising:
forming a card body comprising a first material with at least one plant seed coupled thereto; and
forming an identifier on the card body from a second material selected from a group consisting of a recyclable material and a biodegradable material, for providing data to identify the card body.

19. The method of claim 18, further comprising forming a biodegradable polymeric chip for processing the data.

20. The method of claim 18, wherein the identifier is selected from a group consisting of a magnetic stripe for storing the data and a bar code for providing an optical representation of the data.
